(19) United States
(12) Patent Application Publication
(10) Pub. No.: US 2009/0017252 A1
(43) Pub. Date: Jan. 15, 2009

(54) SEAL WITH RADIUSED CORNERS

(76) Inventor: Lyman Scott Ducworth, Summerville, SC (US)

Correspondence Address: DON W. BULSON (PARK);RENNER, OTTO, BOISSELLE & SKLAR, LLP, 1621 EUCLID AVENUE / 19TH FLOOR, CLEVELAND, OH, 44115, US

(21) Appl. No.: 12/019,698

(22) Filed: Jan. 25, 2008

Related U.S. Application Data
(60) Provisional application No. 60/949,258, filed on Jul. 12, 2007.

(51) Int. Cl. B32B 3/02; B24B 1/00; B24B 31/00

(52) U.S. Cl. 428/66.4; 451/35

(57) ABSTRACT

A process for manufacturing a seal includes providing a seal preform comprising a polymeric material, the seal preform having an end surface adjoining a side surface to define a corner; and agitating the seal preform in a container with an abrasive media to radius the corner of the seal preform.

### CROSS-REFERENCE TO RELATED APPLICATIONS

The present application claims the benefit of the filing date of U.S. Provisional Application Ser. No. 60/949,258, filed Jul. 12, 2007, which is incorporated by reference in its entirety.

### TECHNICAL FIELD

The present invention provides seal members having radiused corners and methods for making seal members, with radiused corners.

### BACKGROUND

Seal members, such as seal rings, having radiused (curved) corners are used in certain applications. For example, it may be desirable to use a seal with radiused corners where the seal is in the vicinity of moving parts. A seal with radiused corners may facilitate the rolling of one surface relative to another. Additionally, where the seal has sharp corners and is in the vicinity of moving parts, the sharp corners of the seal may be pulled away from the seal or worn, which may result in frayed pieces that can clog the device and/or may affect the performance of the seal. Seal members having radiused corners have heretofore been formed by molding processes.

### SUMMARY

The present invention provides a process for manufacturing a seal having a radiused corner. The present invention enables the avoidance of one or more drawbacks associated with the prior art practice of molding seals. The present invention provides a method of forming a seal member that is free of flash, including on the inner diameter, and for providing the seal with radiused corners. The present invention also enables the avoidance of costs associated with molding processes and the avoidance of structural weaknesses caused by voids, knit lines, or flow lines, that result from the previously used molding processes.

According to one aspect of the invention, a process for manufacturing a seal includes providing a seal preform comprising a polymeric material, the seal preform having an end surface adjoining a side surface to define a corner; and agitating the seal preform in a container with an abrasive media to radius the corner of the seal preform.

The step of agitating the seal preform with an abrasive media may include tumbling the tubular structure in a tumbler.

The process may further comprise separating the seal preform from an elongated tubular structure. The elongated tubular structure may be formed by an extrusion process. A plurality of seal preforms may be provided by separating the tubular structure into axial sections by cutting through the tubular structure at an angle relative to the longitudinal axis of the tubular structure. The plurality of seal preforms may then be agitated to provide preforms with a radiused corner.

The agitating step may be carried out for a period of time sufficient to provide the desired degree of curvature on the corner(s). The agitating step may be carried out for a period of time sufficient to remove the corners and provide a seal preform with a substantially circular cross section.

The present invention also provides a seal comprising a polymeric material, the seal having an end surface adjoining a side surface to define a corner, wherein the seal is free of a mold part line and the corner of the seal is radiused.

Further features of the invention will become apparent from the following detailed description when considered in conjunction with the drawings.

### BRIEF DESCRIPTION OF THE DRAWINGS

In the annexed drawings:

FIG. 1 is an axial end view of a seal preform having a sharp corner;

FIG. 2 is a cross-sectional view of the seal preform of FIG. 1 taken along line 2-2;

FIG. 3 is a cross-sectional view of the seal preform having radiused corners formed by a process in accordance with the present invention; and

FIG. 4 is a cross-sectional view of a seal preform formed in accordance with the present invention having a substantially circular cross section.

### DETAILED DESCRIPTION

All ranges and ratio limits disclosed in the specification and claims may be combined in any manner. It is to be understood that unless specifically stated otherwise, references to “a”, “an”, and/or “the” may include one or more than one and that reference to an item in the singular may also include the item in the plural. All combinations specified in the claims may be combined in any manner.

A process in accordance with the present invention may be used to form a seal, which may be used as a seal member in any environment or apparatus as desired for a particular purpose or intended use. Generally, the process comprises providing a seal preform comprising a polymeric material, the seal preform having an end surface adjoining a side surface to define a corner; and agitating the seal preform in a container with an abrasive media to radius the corner of the seal preform.

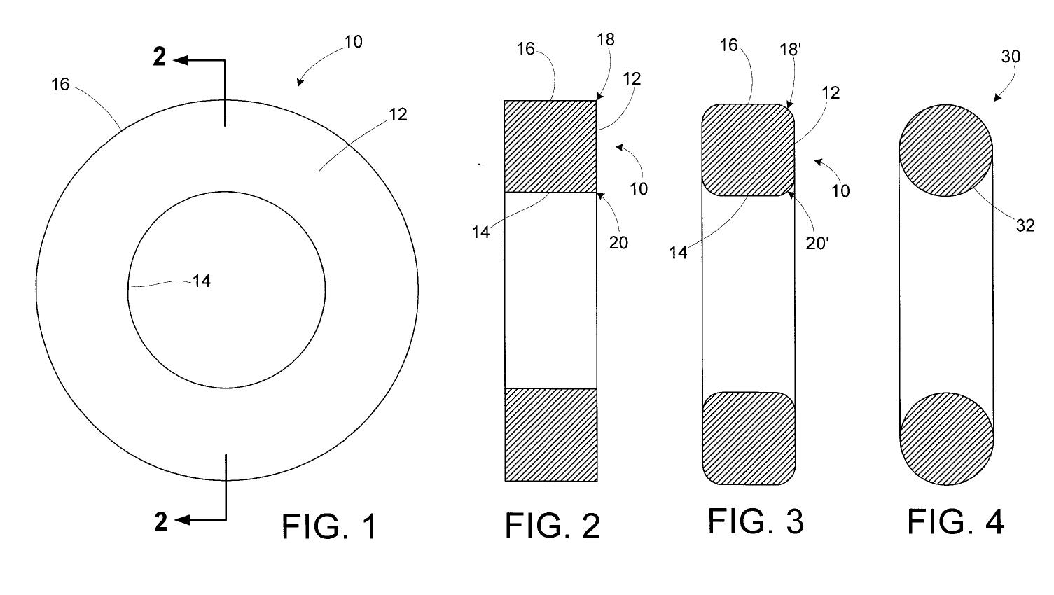

With reference to FIGS. 1 and 2, a seal preform 10 is provided having an end surface 12, a first side surface 14, and a second side surface 16. As shown in FIGS. 1 and 2, the seal preform 10 is an annular seal, and the first and second side surfaces are a radial inner surface 14 and a radial outer surface 16, respectively. The seal preform in FIG. 1 is shown as having a substantially square in cross section, and the side surface 14 adjoins the axial end surface 12 to define a corner 18, and the side surface 16 adjoins the axial end surface 12 to define a corner 20. As shown in FIGS. 1 and 2, the corners 18 and 20 are sharp corners.

In accordance with the present invention, the seal preform 10 is agitated in a container with an abrasive media to radius the corners 18 and 20. FIG. 3 illustrates the seal preform 10 having radiused corners 18′ and 20′.

The seal preform may be provided by extruding a polymeric material to form an elongated structure and separating the elongated structure into axial sections. The elongated structure may have any shape as desired to provide a desired seal shape. For example, the elongated structure may be provided as an elongated tubular structure. The term “elongated structure,” including an elongated tubular structure, may include any elongated structure formed from the extrusion process and to any workpiece formed from the extruded elongated structure prior to being formed as a finished seal. An extruded tubular structure has a radial inner surface, a radial outer surface, and a wall thickness defined by the distance between the inner and outer surfaces. An elongated tubular structure may have any shape as desired for a particular purpose or intended use including, but not limited to, circular, oval, elliptical, rectangular, square, triangular, and the like.

The extruded structure may be separated into axial sections to form a plurality of seal preforms by cutting through the tubular structure at an angle relative to the longitudinal axis of the tubular structure. The tubular structure may be cut at an angle perpendicular to the longitudinal axis or at an angle other than perpendicular to the longitudinal axis to provide an angled outer surface adjacent the axial end face. The extruded elongated structure may be separated into seal preforms using any suitable cutting tool such as a knife, blade, or the like.

The corners of the seal preform are radiused by agitating the seal preform(s) in a container with an abrasive media. Agitating the seal preform(s) may be accomplished by, for example, tumbling the preform(s) in a tumbler, vibrating the preform(s) in a vibrating bowl, or the like. A plurality of preforms may be placed in a container with a selected abrasive media and then agitated for a sufficient period of time to provide a desired degree of rounding of the corners on the preforms.

The abrasive media is not particularly limited and may be chosen as desired for a particular purpose or intended use. Examples of suitable media include porcelain, ceramic, glass, stainless steel, aluminum oxide, sand, and the like. The shape and size of the media is not particularly limited and may be selected as desired. Factors that may affect the choice of material, size, and/or shape of the media include the material used to form the seal preform, and the size and/or dimensions of the seal preform. The abrasive media may be wetted with a fluid such as, for example, water, a detergent, an alcohol, an oil or thickener, or the like. Generally, the fluid should not dissolve the polymeric material used to form the seal member and should not dissolve the abrasive media. A particular suitable abrasive media is a ceramic media wetted with a glycol based fluid.

The process in accordance with the present invention may provide a preform in which the corners have a substantially uniform curvature. For example, the agitating step may provide a seal preform as shown in FIG. 3 having a substantially uniform curvature on both the outer diameter corners 18′ and the inner diameter corners 20′.

The degree of curvature of the radiused corners may be controlled by the length of time in which the seal preform(s) are agitated with the abrasive medium. For example, the preform(s) may be agitated to provide curved corners as shown in FIG. 3. The preform(s) may also be agitated for a length of time sufficient to remove the corners and provide an o-ring seal such as, for example, seal preform 30 illustrated in FIG. 4, which has a surface 32 with a substantially circular cross section.

It may be desirable to monitor the temperature of the container during the agitating process to ensure that the temperature of the container does not exceed the melting point of the polymeric material used to form the seal preforms. If the temperature approaches the melting point of the polymeric material, the agitating process may be stopped, the container may be cooled, and, if desired, the agitating process may subsequently be re-started to continue to radius the corners of the preform(s).

The process in accordance with the present invention may be used to provide seals and seal preforms having any dimension or shape as desired for a particular purpose or intended use. That is, the process is suitable for providing both seals having relatively large or relatively small selected dimensions (e.g., height, width, thickness, etc.). Prior art seals with radiused corners have been formed by molding, but it may be difficult to remove (with a high degree of consistency or uniformity) the flash extensions from the interiors or inner diameters of such pieces, even by agitating the pieces with an abrasive media. The method in accordance with the present invention, however, provides a manner for forming a seal substantially free of flash and providing the seal with radiused corners.

The seal preform may be provided as a unitary, single-layer construction or as a composite multi-layer construction (not illustrated). Multi-layer constructions may include (i) an outermost layer, (ii) an innermost layer, and optionally (iii) one or more layers intermediate the outermost and innermost layers.

The seal preforms may be made from any polymeric material as desired for a particular purpose or intended use. In particular, the material for the core tube may be selected based on the particular application and environment envisioned. Suitable materials for the core tube include, but are not limited to, polymeric materials including thermoplastic materials, such as polyesters, polyurethanes, polyolefins, polyvinyl chlorides (PVCs), polyacetals, ethylene vinyl alcohols (EVAs), polyoxymethylenes (POMs), silicone, thermoplastic rubbers, polyurethanes, or polyamides such as, for example, Nylon 6, 6/66, 11, 12, or 6/12, and the like. Seal preforms may also be formed from a vulcanizable, i.e., thermosetting, or melt-processible, i.e., thermoplastic, natural or synthetic rubber. Suitable rubber materials may include natural or synthetic, thermosetting of vulcanizable rubbers including, but not limited to, nitrile rubber, polyisoprene rubber, buna-N rubber, ethylene-propylene rubber (EPR), ethylene-propylene-diene-monomer (EPDM), nitrile-butadiene rubber (NBR), styrene-butadiene rubber (SBR), blends of rubbers, and the like.

The term “synthetic rubbers” also should be understood to encompass materials that may be classified broadly as thermoplastic or thermosetting elastomers such as polyurethanes, silicones, fluorosilicones, styrene-isoprene-styrene (SIS), and styrene-butadiene-styrene (SBS), as well as other polymers which exhibit rubber-like properties such as plasticized nylons, polyesters, ethylene vinyl acetates, and polyvinyl chlorides. As used herein, the term “elastomeric” may refer to materials exhibiting rubber-like properties of compliancy, resiliency or compression deflection, low compression set, flexibility, and an ability to recover after deformation, i.e., stress relaxation.

As previously described, elongated structures used to form seal preforms may be formed by extrusion processes, which are ascertainable by persons skilled in the art. For example, an elongated structure may be formed by feeding a polymeric material to an extruder and conveying the polymeric material by a screw to a pin and die set at a set pressure. The polymeric material is extruded through an aperture to form a continuous structure having a shape established by the aperture. The aperature may be dimensioned to provide a tube having a shape (e.g., circular, oval, etc.), interior dimensions, and/or wall thickness as desired for a particular purpose or intended use. The extrusion process is not limited in any manner and may employ any type of screw configuration as desired. Additionally, the tubular structure may be formed as a single layer structure or as a multi-layer structure such as by a cross-head or co-extrusion process.

Typically, the extruded structure is extruded as a long continuous structure, e.g., a tube or other desired shape. If desired, the structure may be cut into smaller sections to provide smaller length sections that can be easily handled during further processing.

Optionally, with elastomeric materials such as rubbers, the extruded structure may be cured to provide the material with desired physical properties. For example, an extruded structure may be placed on a curing mandrel and placed in an environment, such as curing vessel, suitable to effect curing the rubber material used to form the tubular structure. Any suitable method including, but not limited to, applying heat and/or pressure to the tubular structure may be used to cure the tubular structure. The structure may be cut into small sections before or after curing.

The use of a curing mandrel is optional and may be desirable to establish a finished inside surface shape and/or dimension within a specified tolerance after curing. A curing mandrel may have any shape and size as desired for a particular purpose or intended use. The shape may be a regular geometric shape, an irregular shape, or may have depressions, grooves, projections, or the like. A curing mandrel may have a relatively smooth surface, or a curing mandrel may have a patterned surface to provide the inner radial surface with a desired surface geometry or pattern.

After curing, the tubular structure(s) may be removed from the curing mandrel and subjected to any secondary or post-curing operations as desired. Such secondary or post-curing operations may be used to establish the final physical properties of an elastomeric compound used to form the tubular structure. Such secondary or post-curing operations are readily known and ascertainable by those skilled in the art of extrusion.

Although the invention has been shown and described with respect to one or more exemplary embodiments, it is appreciated that alterations and modifications may occur to others skilled in the art upon reading and understanding the specification and the annexed drawings without departing from the precepts involved herein. It is intended that all matter contained in the foregoing description shall be interpreted as illustrative and not in a limiting sense. In addition, while a particular feature may have been described with respect to only one or more several illustrated embodiments, such feature may be combined with one or more other features of the other embodiments, as may be desired and advantageous for any given or particular application.

1. A process for manufacturing a seal comprising:
providing a seal preform comprising a polymeric material, the seal preform having an end surface adjoining a side surface to define a corner; and
agitating the seal preform in a container with an abrasive media to radius the corner of the seal preform.

2. The process according to claim 1, wherein the agitating step comprises tumbling the tubular structure in a tumbler.

3. The process according to claim 1, wherein the abrasive media is chosen from porcelain, ceramic, glass, stainless steel, aluminum oxide, or combinations of two or more thereof.

4. The process according to claim 1, wherein the abrasive media is wetted with a fluid.

5. The process according to claim 4, wherein the fluid comprises water.

6. The process according to claim 4, wherein the fluid comprises an alcohol.

7. The process according to claim 1, comprising the further step of separating the seal preform from an elongated tubular structure.

8. The process according to claim 7, comprising (i) separating the tubular structure into axial sections by cutting through the tubular structure at an angle relative to the longitudinal axis of the tubular structure to form a plurality of seal preforms each having an end face adjoining a side surface to define a corner, and (ii) agitating the plurality of seal members in the abrasive media to radius the corners of the seal preforms.

9. The process according to claim 1, wherein the polymeric material is a rubber material.

10. The process according to claim 1, wherein the agitating step is carried out for a period of time sufficient to remove the corners and provide a seal preform with a substantially circular cross section.

11. The process according to claim 1, wherein the seal preform has a substantially rectangular or square cross section prior to agitating the preform.

12. A seal formed by the process according to claim 1.

13. A seal formed by the process according to claim 10.

14. A seal comprising a polymeric material and having an end surface adjoining a side surface to define a corner, wherein the seal is free of a mold part line, and the corner of the seal is radiused.
